(19) United States
(12) Patent Application Publication
(10) Pub. No.: US 2009/0210260 A1
(43) Pub. Date: Aug. 20, 2009

(54) Method and System for Transacting Short Term Hunting Leases

(76) Inventor: Delbert Brown, Falmouth, KY (US)

Correspondence Address: JAMES M. FRANCIS, 300 W VINE ST, STOLL KEENON OGDEN PLLC, LEXINGTON, KY, 40507, US

(21) Appl. No.: 12/390,378

(22) Filed: Feb. 20, 2009

Related U.S. Application Data
(60) Provisional application No. 61/030,030, filed on Feb. 20, 2008.

(51) Int. Cl. G06Q 30/00; G06Q 10/00; G06Q 40/00; G06F 3/048; G06F 15/16; G06Q 50/00

(52) U.S. Cl. 705/4; 705/26; 705/5; 715/705; 705/10; 709/204

(57) ABSTRACT

A method for an online reservation and rating system for short-term hunting leases for property. In the preferred embodiment, hunters can lease hunting rights for as little as 1 day. The properties are categorized and rated on a variety of variable of interest to hunters. Relevant information on hunting laws, regulations, rules, and licensing are made available through the website. Hunters can also obtain information about the property and surrounding area as well as determine the types of game available. Hunters may also apply for hunter's insurance through the website. Landowner's may list their property and the terms and conditions of the lease. Payment is preferably made through the website at the time of reservation.

### CROSS REFERENCE TO RELATED APPLICATIONS

This application claims priority from U.S. Provisional Application No. 61/030,030 filed on Feb. 20, 2008, and entitled “Method and System for Transacting Short Term Hunting Leases.” The entire disclosure contained in U.S. Provisional Application No. 61/030,030 including the attachments thereto, are incorporated herein by reference.

### FIELD OF THE INVENTION

This invention relates generally to internet based service portals accessed via a computer and run from machine readable media on a web server.

### SUMMARY OF THE INVENTION

The present invention is for an online reservation and rating system for short-term hunting leases for property. In the preferred embodiment, hunters can lease hunting rights for as little as 1 day. The properties are categorized and rated on a variety of variable of interest to hunters. Relevant information on hunting laws, regulations, rules, and licensing are made available through the website. Hunters can also obtain information about the property and surrounding area as well as determine the types of game available. Hunters may also apply for hunter's insurance through the website. Landowner's may list their property and the terms and conditions of the lease. Payment is preferably made through the website at the time of reservation.

### DETAILED DESCRIPTION OF THE INVENTION

A service portal, developed in machine readable code, is accessed electronically, preferably over the internet, from a computer. Property owners, via the service portal, may list property available for a short-term lease of hunting rights to hunters by first entering information into an electronic database as a record. The information is then made accessible by conducting a search of the database records either locally or remotely. Hunters may make reservations for listed property for available dates. As dates are taken they are delisted or marked as unavailable for dates where reservations cannot be confirmed.

The method and computer program permits property owners, through the service portal, to manage the availability of their property and indicate such availability to interested parties. Fees associated with said lease may also be listed and managed through the website. It is a further feature that the hunter(s) will be permitted to complete the transaction for the lease online, including agreeing to the terms and conditions of the lease electronically as well as making the appropriate payment(s). An optional embodiment of the invention permits groups of two or more hunters to pay their respective portions independently of the other(s) as well as provide electronic signatures to indicate agreement with terms and conditions. An e-mail or other electronic communication confirms the reservation and a transaction receipt message is generated at the conclusion of the transaction.

It is envisioned that additional services can be made available and ordered/reserved through this system. Meals could be ordered. Rooms could be made available for those hunters not interested in camping. Fires could be made ready and special game could be made available.

The hunter(s) may fill out and submit a waiver of liability and agreement with lease terms and conditions either electronically or by printing and mailing the waiver. The hunter(s) may also apply for hunter's insurance through the website so that they can obtain insurance coverage should they become injured or cause injury to others or the land and structures associated with the land. It is a further feature that property owners may apply for insurance to protect them from claims made by hunter's and other third parties through the website. The owner of the service portal can act as the broker or arrange some form of compensation from a broker for acting as a referral source for these insurance policies.

Additionally, property owners may rate each hunter as to compliance with laws, rules, regulations as well as terms of use related to the hunter's use of the property. The website provides access to information on hunting laws, rules and regulations for the jurisdiction in which said property is found. The website also provides access to information on hunting licenses and permits and, when applicable, permits the hunter to apply for necessary licenses and permits online. A further embodiment permits hunters to rate each piece of property and/or owner as well as the overall experience from their short term lease.

In a further embodiment, the website further provides access to information on hunter safety and hunter education either for free or for profit. The website can also provide access to climate and weather information for the area as well as provide emergency contact information so that the hunter(s) can be reached through the landowner. The website may also provide access to information on mobile telephone coverage for said property and, when requested, can provide satellite phones or two-way radio's for the hunter's use.

The property is rated according to variables of interest to hunters and the listings are searchable based on the selection of preferred criteria by the user. The program can calculate various indices based upon the requirements of the searcher and the ratings of the property. These indices are sortable so as to provide a customized and optimized match for the searcher. Ideally the rating is conducted by a third party and follows a uniform set of guidelines so that each property may be objectively compared.

The variables may be selected from following non-exclusive list: terrain, game types, game populations, property size, location, distance from population centers, hazards, hunting party capacity of property, hunter enjoyment, campsite quality, campsite quantity, campsite terrain, mobile telephone system signal strength, mobile telephone service provider coverage, distance to accommodations, lease fees, lease availability by date, lease availability by hunting season, lease availability by hunting season and game type, property accessibility, property accessibility by disability, distance to taxidermists, distance to game butcher shops, all-terrain vehicle availability, all-terrain vehicles allowed, all-terrain vehicle accessibility, tree-stands available, distance to hunter's supply stores, hunters under-18 years old permitted, game quotas, distance to grocery stores, and distance to convenience stores, and distance to gas stations.

What is claimed is:

1. A method comprising accessing a service portal via a computer wherein property owners, via an internet website, may offer a short-term lease on property hunting rights to interested parties and interested parties may make reservations for available dates, wherein said website generates a reservation for said property for available lease dates.

2. The method of claim 1, wherein said property owners, through said service portal, may manage the availability of said property and visually indicate such availability to interested parties.

3. The method of claim 2, wherein said property owners may manage the fees associated with said lease.

4. The method of claim 3, wherein said interested parties may complete a leasing transaction for said hunting rights through said service portal.

5. The method of claim 4, wherein said interested parties may fill out and submit a waiver of liability.

6. The method of claim 5, wherein said interested parties may apply for hunter's insurance through said service portal.

7. The method of claim 6, wherein said property owners may apply for insurance to protect them from claims made by hunters and other third parties through said service portal.

8. The method of claim 7, wherein said property owners may rate said interested parties compliance with laws, rules and regulations related to their use of said property.

9. The method of claim 8, wherein said service portal provides access to information on hunting laws, rules and regulations for the jurisdiction in which said property is found.

10. The method of claim 9, wherein said service portal provides access to information on hunting licenses and permits for the jurisdiction in which said property is found.

11. The method of claim 10, wherein said service portal provides access to information on hunter safety.

12. The method of claim 11, wherein said service portal provides access to hunter education.

13. The method of claim 12, wherein said service portal provides access to weather information.

14. The method of claim 13, wherein said service portal provides access to emergency contact information for said property.

15. The method of claim 14, wherein said service portal provides access to information on mobile telephone coverage for said property.

16. The method of claim 1, wherein said property is rated according to variables of interest to hunters.

17. The method of claim 16, wherein said rating is conducted by a third party.

18. The method of claim 16, wherein said variables are selected from the group consisting of terrain, game variety, game populations, property size, location, distance from population centers, hazards, hunting party capacity of property, hunter enjoyment, campsite quality, campsite quantity, campsite terrain, mobile telephone system signal strength, mobile telephone service provider coverage, distance to accommodations, lease fees, lease availability by date, lease availability by hunting season, lease availability by hunting season and game type, property accessibility, property accessibility by disability, distance to taxidermists, distance to game butcher shops, all-terrain vehicle availability, all-terrain vehicles allowed, all-terrain vehicle accessibility, tree-stands available, distance to hunter's supply stores, hunters under-18 years old permitted, game quotas, distance to grocery stores, and distance to convenience stores, distance to gas stations.

19. The method of claim 1, wherein said service portal generates a confirmation message sent electronically when said reservation is made.

20. A machine readable medium having stored thereon a set of instructions which, when executed, perform the method of claim 1 and its dependant claims.
